(19) United States
(12) Patent Application Publication
(10) Pub. No.: US 2011/0074986 A1
(43) Pub. Date: Mar. 31, 2011

(54) BLACK LEVEL ADJUSTING APPARATUS, METHOD FOR THE SAME, AND SOLID-STATE IMAGING DEVICE

(75) Inventor: Maki OGATA, Kanagawa (JP)

(73) Assignee: Kabushiki Kaisha Toshiba, Tokyo (JP)

(21) Appl. No.: 12/853,605

(22) Filed: Aug. 10, 2010

(30) Foreign Application Priority Data
Sep. 25, 2009 (JP) 2009-220902

(51) Int. Cl. H04N 9/64

(52) U.S. Cl. 348/243; 348/E09.037

(57) ABSTRACT

According to one embodiment, a black level adjusting apparatus includes a black-level correcting unit that generates a clamp parameter based on an OB value (a pixel signal value) obtained by A/D-converting, with an A/D conversion circuit, an imaging signal of an optical black section of a solid-state imaging device and feeds back clamp voltage corresponding to the clamp parameter to the A/D conversion circuit. The black-level correcting unit updates the clamp parameter using a linear relation between the clamp parameter and the OB value.

### CROSS-REFERENCE TO RELATED APPLICATIONS

This application is based upon and claims the benefit of priority from the prior Japanese Patent Application No. 2009-220902, filed on Sep. 25, 2009; the entire contents of which are incorporated herein by reference.

### FIELD

Embodiments described herein relate generally to a black level adjusting apparatus, a method for the same, and a solid-state imaging device.

### BACKGROUND

It is conventionally known that an imaging signal of a solid-state imaging device of a complementary metal oxide semiconductor (CMOS) image sensor includes noise equivalent to a black level by dark current. As a black level correcting method, there is a publicly-known method of acquiring a black level from pixels in a section shielded from light and subtracting the black level from a signal level of an effective pixel area not shielded from light.

For example, Japanese Patent Application Laid-Open No. 2003-209713 discloses a technology for determining, according to whether an OB error belongs to a correction range in which an effect of correction is obtained when an error detector changes an input signal level of a digital to analog converter (DAC) by one step, whether an input signal level of the DAC should be changed.

However, in Japanese Patent Application Laid-Open No. 2003-209713, the correction range used for black level correction is treated as a range that can be fixedly grasped according to specifications of a digital/analog (D/A) conversion circuit and specifications of an analog/digital (A/D) conversion circuit. The correction range used for the black level correction is determined based on a table in which correction ranges are stored in advance. Therefore, when A/D conversion is performed by using a reference waveform, if fluctuation occurs in a characteristic of a reference wave generating circuit, in some case, a correct correction range cannot be determined.

### BRIEF DESCRIPTION OF THE DRAWINGS

FIG. 1 is a diagram of a circuit configuration of a CMOS image sensor to which a black level correcting apparatus according to an embodiment is applied;

FIG. 2 is a circuit diagram of a specific configuration example of a pixel unit and an A/D conversion circuit in the CMOS image sensor shown in FIG. 1;

FIG. 3 is a diagram for explaining light shielded pixels and light receiving pixels of the pixel unit;

FIG. 4 is a diagram for explaining pixel signal values of the light shielded pixels and the light receiving pixels;

FIG. 5A is a diagram for explaining A/D conversion operation by the A/D conversion circuit;

FIG. 5B is a diagram for explaining the A/D conversion operation by the A/D conversion circuit;

FIG. 6 is a diagram for explaining a clamp parameter CLAMP_PARAM and an OB value in the related art;

FIG. 7 is a diagram for explaining a clamp parameter CLAMP_PARAM and an OB value in this embodiment;

FIG. 8 is a diagram of a configuration example of a clamp-parameter generating circuit; and

FIG. 9 is a flowchart for explaining operation for generating a clamp parameter CLAMP_PARAM by the clamp-parameter generating circuit.

### DETAILED DESCRIPTION

In general, according to one embodiment, a black level adjusting apparatus includes a black-level correcting unit that generates a clamp parameter based on an OB value (a pixel signal value) obtained by A/D-converting, with an A/D conversion circuit, an imaging signal of an optical black section of a solid-state imaging device and feeds back clamp voltage corresponding to the clamp parameter to the A/D conversion circuit, wherein the black-level correcting unit updates the clamp parameter using a linear relation between the clamp parameter and the OB value.

Exemplary embodiments of a black level adjusting apparatus, a method for the same, and a solid-state imaging device will be explained below in detail with reference to the accompanying drawings. The present invention is not limited to the following embodiments.

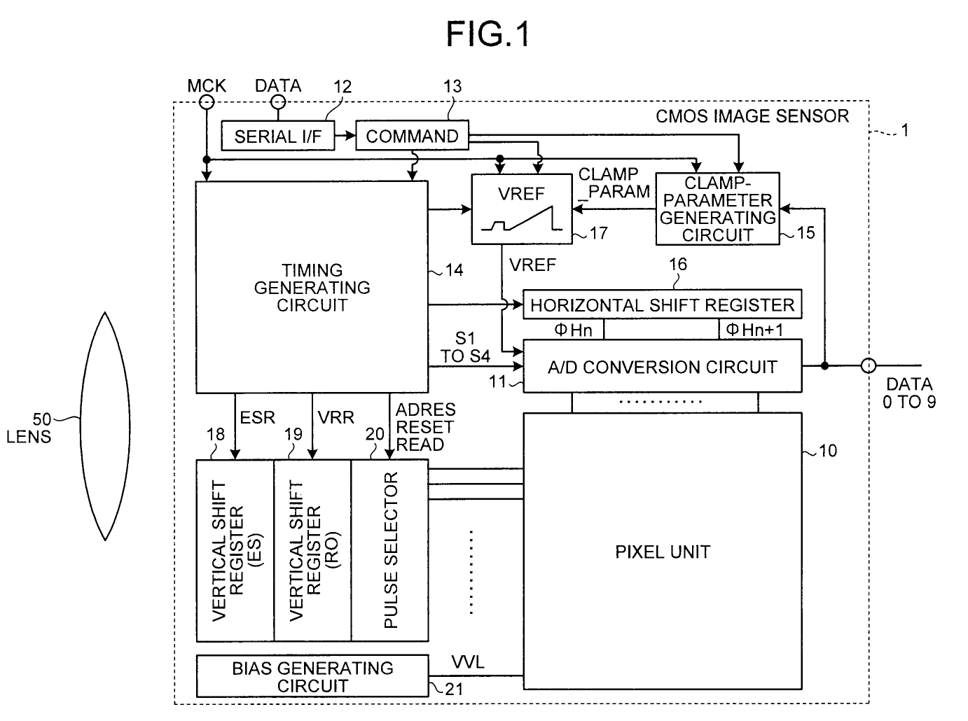

FIG. 1 is a diagram of a circuit configuration of an amplification-type CMOS image sensor 1 to which a black level adjusting apparatus and a black level adjusting method according to an embodiment of the present invention are applied. The CMOS image sensor 1 includes, as shown in FIG. 1, a pixel unit 10, an A/D conversion circuit 11, a serial interface (I/F) 12, a command control circuit 13, a timing generating circuit 14, a clamp-parameter generating circuit 15, a horizontal shift register 16, a VREF generating circuit 17, a vertical shift register (ES) 18, a vertical shift register (RO) 19, a pulse selector 20, and a bias generating circuit 21.

The serial I/F 12 captures data DATA supplied from the outside and supplies the data DATA to the command control circuit 13. The command control circuit 13 generates a command corresponding to the data DATA supplied from the serial I/F 12 and outputs the command to the timing generating circuit 14, the clamp-parameter generating circuit 15, and the VREF generating circuit 17.

In the pixel unit 10, a plurality of cells (pixels) including a plurality of transistors and photodiodes PD are two-dimensionally arranged. Light is made incident on the pixel unit 10 via a lens 50. Charges corresponding to an amount of the incident light are generated by photoelectric conversion. A 10-bit column-type A/D conversion circuit 11 including a noise cancel circuit is arranged above the pixel unit 10. Analog signals corresponding to the charges generated by the pixel unit 10 are supplied to the A/D conversion circuit 11, converted into digital signals, and latched. The latched digital signals are sequentially transferred by the horizontal shift register 16 and read out. Digital signals OUT0 to OUT9 read out from the horizontal shift register 16 are output to the outside.

The A/D conversion circuit 11 converts, based on a level of a triangle wave from the VREF generating circuit 17, signals from the cells into 10-bit digital signals at 0 to 1023 levels using a comparator and a 10-bit digital counter. The clamp-parameter generating circuit 15 and the VREF generating circuit 17 are circuits that adjust an imaging signal of an optical black section of the pixel unit 10 such that a pixel signal value obtained by A/D-converting the imaging signal with the A/D conversion circuit 11 (hereinafter, “OB value”) coincides with a black level reference value. The clamp-parameter generating circuit 15 and the VREF generating circuit 17 function as a black level correcting unit that generates a clamp parameter CLAMP_PARAM based on the OB value and the black level reference value and feeds back clamp voltage corresponding to the clamp parameter CLAMP_PARAM to the A/D conversion circuit 11.

The clamp parameter generating circuit 15 generates the clamp parameter CLAMP_PARAM for controlling the clamp voltage at a reset level of the triangle wave and outputs the clamp parameter CLAMP_PARAM to the VREF generating circuit 17.

The VREF generating circuit 17 is a circuit that operates in response to a main clock signal MCK, generates a reference waveform VREF (the triangle wave and the clamp voltage) for A/D conversion (ADC), and supplies the reference waveform VREF to the A/C conversion circuit 11. The amplitude of the triangle wave is controlled according to the data DATA input to the serial interface (serial I/F) 12. The clamp voltage is controlled according to the clamp parameter CLAMP_PARAM input from the clamp-parameter generating circuit 15.

The vertical shift register (ES) 18 for signal readout, the vertical shift register (RO) 19 for accumulation time control, and the pulse selector 20 are arranged adjacent to the pixel unit 10.

A command input to the serial interface 12 is decoded by the command decoder 13 and supplied to the timing generating circuit 14 together with the main clock signal MCK. Readout from the pixel unit 10 is performed according to pulse signals S1 to S4, ESR, VRR, RESET, ADRES, and READ output from the timing generating circuit 14. The pulse signals S1 to S4 are supplied to the A/D conversion circuit 11, the pulse signal ESR is supplied to the vertical shift register (ES) 18, the pulse signal VRR is supplied to the vertical shift register (RO) 19, and the pulse signals RESET, ADRES, and READ are supplied to the pulse selector 20. A vertical line of the pixel unit 10 is selected by the vertical register (ES) 18 and the vertical register (RO) 19. The pulse signals RESET, ADRES, and READ are supplied to the pixel unit 10 via the pulse selector 20. Bias voltage VVL is applied to the pixel unit 10 from the bias generating circuit 21.

Specifically, in the cells of the pixel unit 10, signals accumulated in the photodiodes (PD) of a horizontal line selected by the vertical shift register (ES) 18 are discharged. Accumulation time of the cells is set according to DATA supplied from the outside. The accumulation time corresponds to the number of horizontal lines between a horizontal line selected by the vertical shift register (RO) 19 and a horizontal line selected by the vertical shift register (ES) 18. The vertical shift register (ES) 18 selects the horizontal line before the selection by the vertical shift register (RO) 19. The horizontal line selected by the vertical shift register (ES) 19 is apart from the horizontal line selected by the vertical shift register (RO) 19 by a fixed number of lines. Consequently, a signal amount accumulated in the photodiodes (PD) is controlled. After the accumulation time, in the cells, signals of the photodiodes (PD) in the horizontal line selected by the vertical shift register (RO) 18 are read out.

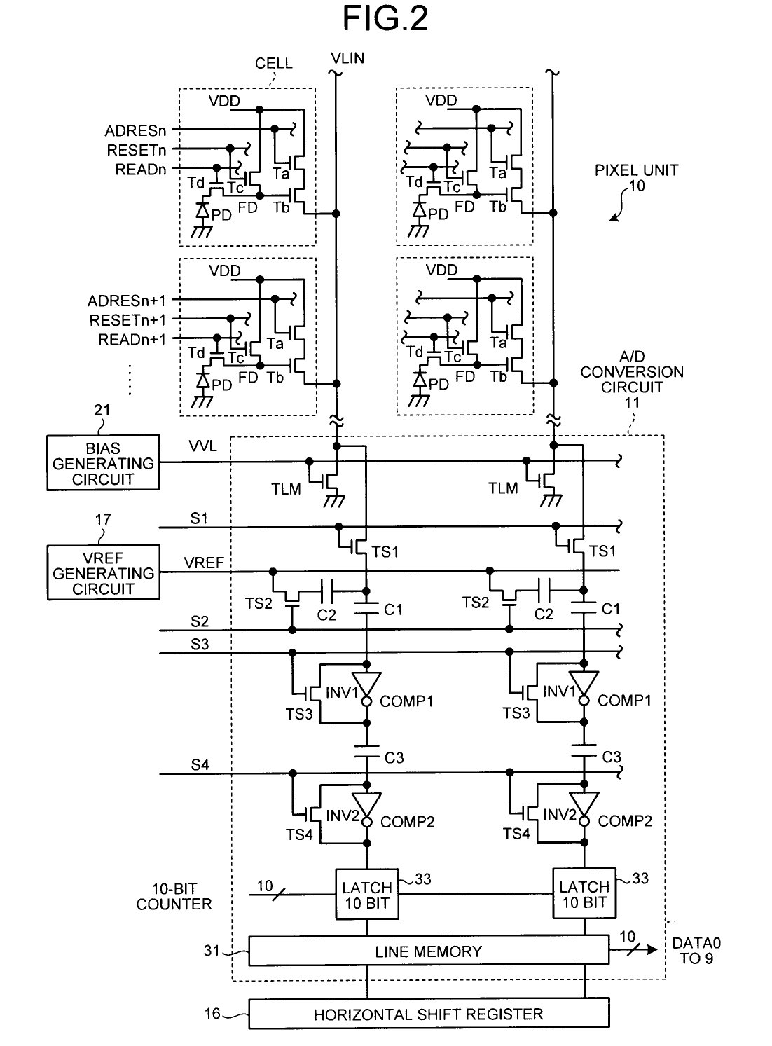

FIG. 2 is a circuit diagram of a specific configuration example of the pixel unit 10 and the A/D conversion circuit 11 in the CMOS image sensor 1 shown in FIG. 1. Each of the cells (pixels) in the pixel unit 10 includes a row selection transistor Ta, an amplification transistor Tb, a reset transistor Tc, a readout transistor Td, and a photodiode PD. Current passages of the transistors Ta and Tb are connected in series between a power supply VDD and a vertical signal line VLIN. A pulse signal ADRESn is supplied to a gate of the transistor Ta. A current passage of the transistor Tc is connected between the power supply VDD and a gate (a detecting section FD) of the transistor Tb. A pulse signal RESETn is supplied to the gate. One end of a current passage of the transistor Td is connected to the detecting section FD. A pulse signal READn is supplied to the gate. A cathode of the photodiode PD is connected to the other end of the current passage of the transistor Td. An anode of the photodiode PD is grounded.

Load transistors TLM for a source follower circuit are arranged in the horizontal direction below the pixel unit 10. Current passages of the load transistors TLM are connected between the vertical signal line VLIN and a ground point. The bias voltage VVL is applied to gates of the load transistors TLM from the bias generating circuit 21. In the A/D conversion circuit 11, capacitors C1 and C2 for a noise canceller are arranged. Further, a transistor TS1 for transmitting a signal of the vertical signal line VLIN, a transistor TS2 for inputting a reference waveform for A/D conversion, and two stages of comparator circuits COMP1 and COMP2 are arranged. A capacitor C3 is connected between the comparator circuits COMP1 and COMP2.

The comparator circuit COMP1 includes an inverter INV1 and a transistor TS3, a current passage of which is connected between an input terminal and an output terminal of the inverter INV1. The comparator circuit COMP2 includes an inverter INV2 and a transistor TS4, a current circuit of which is connected between an input terminal and an output terminal of the inverter INV2. The pulse signal S1, the pulse signal S2, the pulse signal S3, and the pulse signal S4 output from the timing generating circuit 14 are respectively supplied to a gate of the transistor TS1, a gate of the transistor TS2, a gate of the transistor TS3, and a gate of the transistor TS4. A digital signal output from the comparator circuit COMP2 is latched by a latch circuit 33 and transferred to a line memory 31 and then causes the horizontal shift register 16 to operate. 10-bit digital signals DATA0 to DATA9 are sequentially output.

In the configuration explained above, for example, to read out signals of n lines of the vertical signal line VLIN, the pulse signal ADRESn is set to an “H” level to cause a source follower circuit including the amplification transistor Tb and the load transistor TLM to operate. Signal charges obtained by photoelectric conversion in the photodiode PD are accumulated for a fixed period. To remove a noise signal such as dark current in the detecting section FD before performing readout, the pulse signal RESETn is set to the “H” level and the transistor Tc is turned on to set the detecting section FD to VDD voltage=2.8 volts. Consequently, reference voltage (a reset level) in a state without a signal in the detecting section FD is output to the vertical signal line VLIN. At this point, the pulse signals S1, S3, and S4 are set to the “H” level and the transistors TS1, TS3, and TS4 are turned on to set an A/D conversion level of the comparator circuits COMP1 and COMP2 and accumulate an amount of charges corresponding to the reset level of the vertical signal line VLIN in the capacitor C1. At this point, the amplitude of the triangle wave VREF output from the VREF generating circuit 17 is set to an intermediate level (clamp voltage) to perform readout. The clamp voltage is a signal level of light shielded pixels (OB) section of the pixel unit 10. Black level adjustment is performed by adjusting the clamp voltage such that a value obtained by A/D-converting the signal level coincides with 64 LSB (a black level reference value).

Subsequently, the pulse signal (a readout pulse) READn is set to “H” level and the readout transistor Td is turned on. The signal charges generated and accumulated by the photodiode PD are read out to the detecting section FD. Consequently, a voltage (signal+reset) level of the detecting section FD is read out to the vertical signal line VLIN. At this point, the pulse signal S1 is set to the “H” level, the pulse signal S3 is set to an “L” level, the pulse signal S4 is set to the “L” level, and the pulse signal S2 is set to the “H” level. Then, the transistor TS1 is turned on, the transistor TS3 is turned off, the transistor TS4 is turned off, and the transistor TS2 is turned on. Charges corresponding to “the signal of the vertical signal line VLIN+the reset level” are accumulated in the capacitor C2. In this case, because an input terminal of the comparator circuit COMP1 is in a high-impedance state, the reset level is maintained in the capacitor C1.

Thereafter, the level of the triangle wave VREF is increased to be A/D-converted by the comparator circuits COMP1 and COMP2 via a combined capacitor of the capacitors C1 and C2. The triangle wave is generated at 10 bits (0 to 1023 levels). An A/D conversion level is determined by a 10-bit counter and data of the A/D conversion level is stored by the latch circuit 33. After the A/D conversion of the 1023 level, the data in the latch circuit 33 is transferred to the line memory 31. The reset level accumulated in the capacitor C1 has polarity opposite to the polarity of the reset level accumulated in the capacitor C2. Therefore, the reset level is cancelled and the A/D conversion is substantially executed with a signal component of the capacitor C2. This operation for removing the reset level is referred to as noise-reduction processing operation (correlated double sampling (CDS) operation).

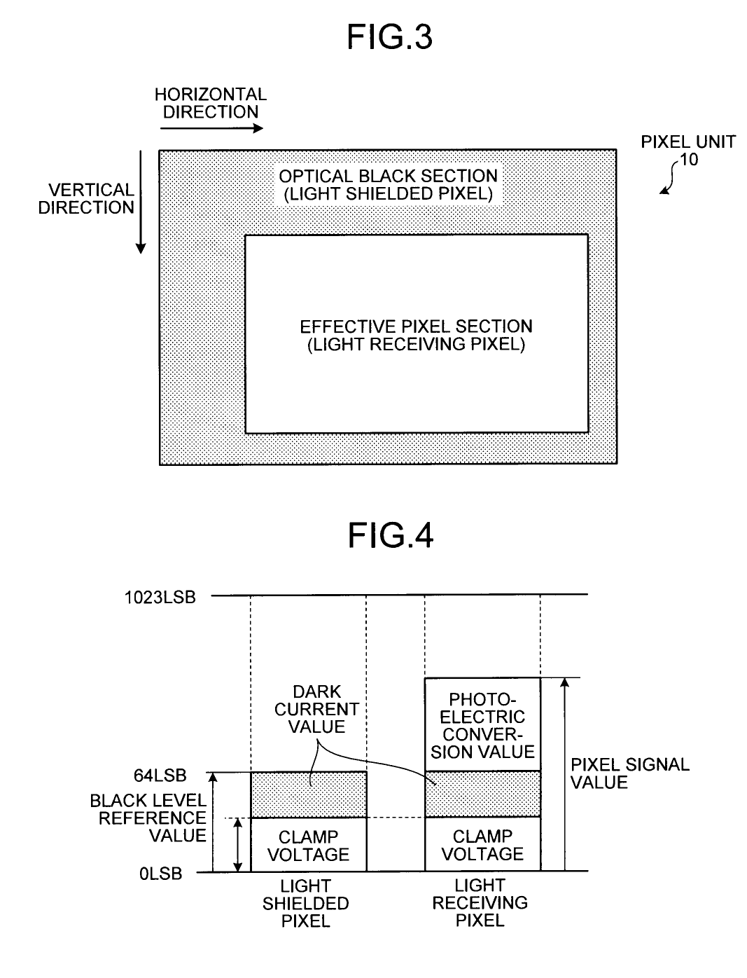

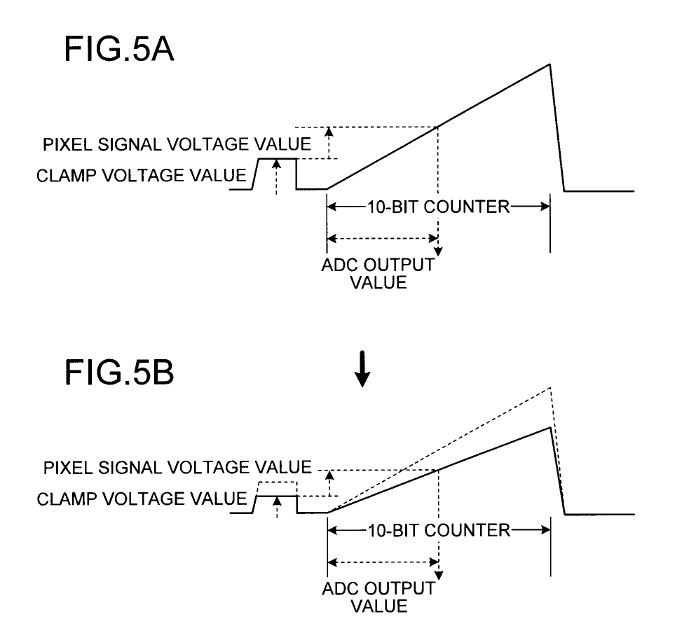

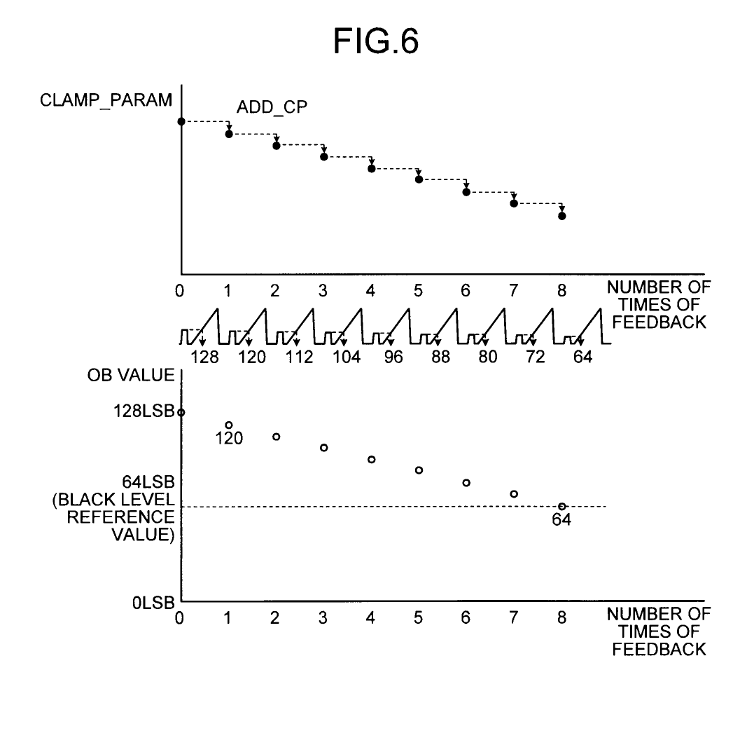

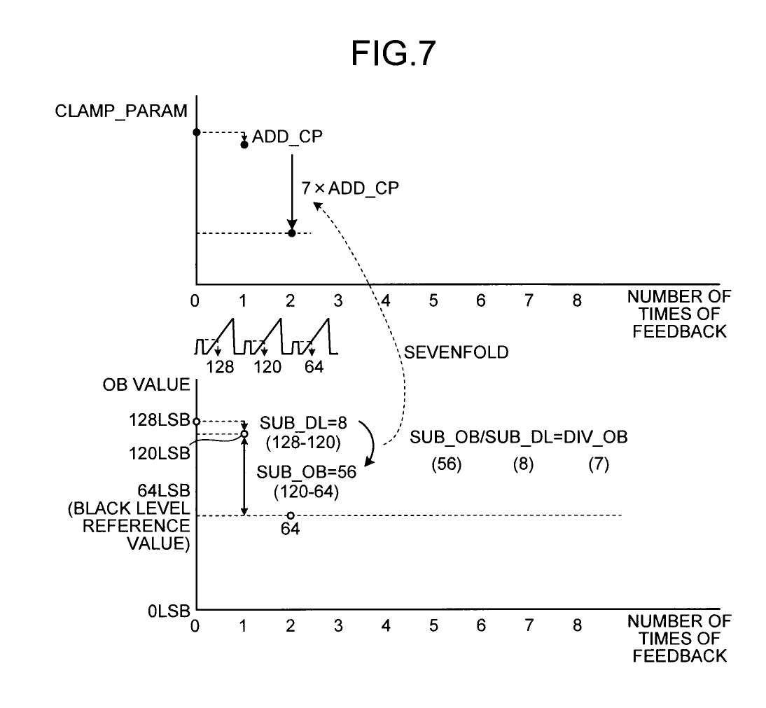

A principle of black level adjustment by the clamp-parameter generating circuit 15, the VREF generating circuit 17, and the A/D conversion circuit 11 is explained below with reference to FIGS. 3 to 7. FIG. 3 is a diagram for explaining light shielded pixels and light receiving pixels of the pixel unit 10. FIG. 4 is a diagram for explaining pixel signal values of the light shielded pixels and the light receiving pixels. FIGS. 5A and 5B are diagrams for explaining A/D conversion operation by the A/D conversion circuit 11. FIG. 6 is a diagram for explaining a clamp parameter CLAMP_PARAM and an OB value in the related art. FIG. 7 is a diagram for explaining a clamp parameter CLAMP_PARAM and an OB value in this embodiment.

As shown in FIG. 3, the pixel unit 10 includes light shielded pixels in a section shielded from light (an optical black section) and light receiving pixels in a section illuminated by light (an effective pixel section). As shown in FIG. 4, a pixel signal value of the light shielded pixels includes clamp voltage and a dark current value. A pixel signal value of the light receiving pixels includes clamp voltage, a dark current value, and a photoelectric conversion component. In this way, the pixel signal value of the light receiving pixel includes the clamp voltage and the dark current value that are generated even in a state in which the pixel is not illuminated by light. Therefore, a black level reference is generated by using the light shielded pixels.

As shown in FIG. 5A, the A/D conversion circuit 11 sets, using the triangle wave VREF generated by the VREF generating circuit 17, as a pixel signal value, a value of the digital counter at the time when VREF coincides with clamp voltage+a pixel signal voltage value (a value which clamp voltage and a pixel signal voltage value is added to). An analog gain depends on the tilt of VREF. As shown in FIG. 5B, when a value of the analog gain is increased, the tilt of VREF decreases and clamp voltage necessary for obtaining the same pixel signal value is reduced.

As explained above, black level adjustment is operation for adjusting the clamp voltage such that an OB value coincides with 64 LSB. Specifically, an acquired OB value is compared with the black level reference value (64 LSB). When the OB value is large, the clamp parameter CLAMP_PARAM is reduced. On the other hand, when the OB value is small, the CLAMP_PARAM is increased. The adjustment of the clamp voltage is repeated until a difference between the OB value and the black level reference value is reduced to zero.

The clamp parameter CLAMP_PARAM is associated with the analog gain. Therefore, when an analog gain parameter is represented as AG_PARAM, ADD_CP=(1/2)̂kx(1/AG_PARAM) (k=1 to 8).

A black level adjusting method in the past is explained with reference to FIG. 6. In FIG. 6, the abscissa indicates the number of times of feedback and the ordinate indicates the clamp parameter CLAMP_PARAM and the OB value. As shown in FIG. 6, the OB value before the start of black level adjustment is 128 LSB. Therefore, the clamp parameter CLAMP_PARAM used for the next A/D conversion is reduced by ADD_CP (e.g., eight). The next OB value (in first feedback) is 120 LSB. Therefore, because the OB value is larger than the reference value 64 LSB, the clamp parameter CLAMP_PARAM is reduced by ADD_CP again. When the operation is repeated and the feedback is performed eight times, the OB value coincides with 64 LSB and the black level adjustment is completed.

When the analog gain is large, i.e., the tilt of VREF is small, a value of ADD_CP is small and the clamp parameter CLAMP_PARAM can be increased or reduced only little by little. In the black level adjusting method in the past, the value of ADD_CP is a fixed value. Therefore, when the OB value substantially deviates from the black level reference value, it takes time for the OB value to converge to the black level reference value. In an example shown in FIG. 6, feedback needs to be performed eight times. When a value of a coefficient k is set small, ADD_CP increases. However, because the width of increase and decrease of the clamp parameter CLAMP_PARAM increases, in some case, the OB value cannot converge to the black level reference value.

As shown in FIG. 6, there is a linear relation between the clamp parameter CLAMP_PARAM and the OB value. Therefore, in this embodiment, a method of accurately calculating, using the linear relation between the clamp parameter CLAMP_PARAM and the OB value, a correction range even if there is fluctuation in a circuit characteristic and causing the OB value to quickly converge to the black level reference value is proposed. Specifically, an OB value corresponding to the clamp parameter CLAMP_PARAM set to a predetermined value is acquired, ADD_CP (a reference adjustment amount) is subtracted from the predetermined value of the clamp parameter CLAMP_PARAM to update the clamp parameter CLAMP_PARAM, and an OB value corresponding to the updated clamp parameter CLAMP_PARAM is acquired. The OB value corresponding to the updated clamp parameter CLAMP_PARAM is subtracted from the OB value corresponding to the clamp parameter CLAMP_PARAM set to the predetermined value to calculate a first difference (SUB_DL). The black level reference value is subtracted from the OB value corresponding to the updated clamp parameter CLAMP_PARAM to calculate a second difference (SUB_OB). According to the linearity of the OB value and the clamp parameter CLAMP_PARAM, the second difference is divided by the first difference to obtain a value (SUB_OB/SUB_DL), a value obtained by multiplying the value (SUB_OB/SUB_DL) with ADD_CP (the reference adjustment value) is subtracted from the updated clamp parameter CLAMP_PARAM to update the clamp parameter CLAMP_PARAM, and the OB value is caused to coincide with the black level reference value.

A black level adjusting method according to this embodiment is specifically explained with reference to FIG. 7. In FIG. 7, the abscissa indicates the number of times of feedback and the ordinate indicates the clamp parameter CLAMP_PARAM and the OB value. As shown in FIG. 7, the OB value before the start of black level adjustment (when the clamp parameter CLAMP_PARAM is the predetermined value) is 128 LSB.

In the first feedback, as in the related art, the OB value is obtained by using the clamp parameter CLAMP_PARAM obtained by reducing the clamp parameter CLAMP_PARAM by ADD_CP (e.g., one). The OB value is reduced by 8 LSB (SUB_DL) to 120 LSB. A difference (SUB_OB) between the black level reference value and the present OB value is 56 LSB. Therefore, if the clamp parameter CLAMP_PARAM obtained by reducing ADD_CP multiplied by SUB_OB/SUB_DL (=DIV_OB), i.e., ADD_CP multiplied by (56/8=7) from the present clamp parameter CLAMP_PARAM is used in second feedback, the OB value is 64 LSB. The OB value can be caused to coincide with the black level reference value.

In this way, the feedback only has to be performed twice. Compared with the related art, black adjustment can be performed at high speed.

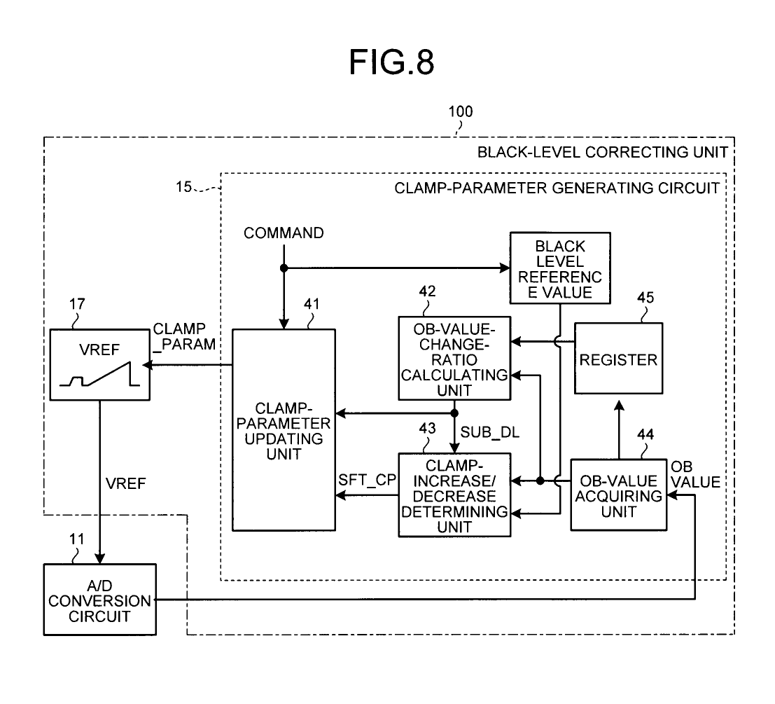

FIG. 8 is a diagram of the configuration of the clamp-parameter generating circuit 15. The clamp-parameter generating circuit 15 includes, as shown in FIG. 8, a clamp-parameter updating unit 41, an OB-value-change-ratio calculating unit 42, a clamp-increase/decrease determining unit 43, an OB-value acquiring unit 44, and a register 45. A black-level correcting unit 100 includes the clamp-parameter generating circuit 15 and the VREF circuit 17.

The OB-value acquiring unit 44 calculates an average of OB values in a horizontal line (1H). The OB-value-change-ratio calculating unit 42 calculates a difference SUB_DL between the present average of the OB values and an average of OB values in the previous horizontal line stored in the register 45 and outputs the difference SUB_DL to the clamp increase/decrease determining unit 43.

The clamp-increase/decrease determining unit 43 calculates a difference SUB_OB between the present average of the OB values in horizontal line and the black level reference value (64 LSB), divides SUB_OB by SUB_DL to calculate DIV_OB=SUB_OB/SUB_DL, and calculates how many times SUB_OB is as large as SUB_DL. The clamp-increase/decrease determining unit 43 outputs an adjustment value SFT_CP obtained by multiplying ADD_CP and DIV_OB together to the clamp-parameter updating unit 41.

The clamp-parameter updating unit 41 subtracts the adjustment value SFT_CP from the clamp parameter CLAMP_PARAM to update the clamp parameter CLAMP_PARAM and outputs the updated clamp parameter CLAMP_PARAM to the VREF generating circuit 17.

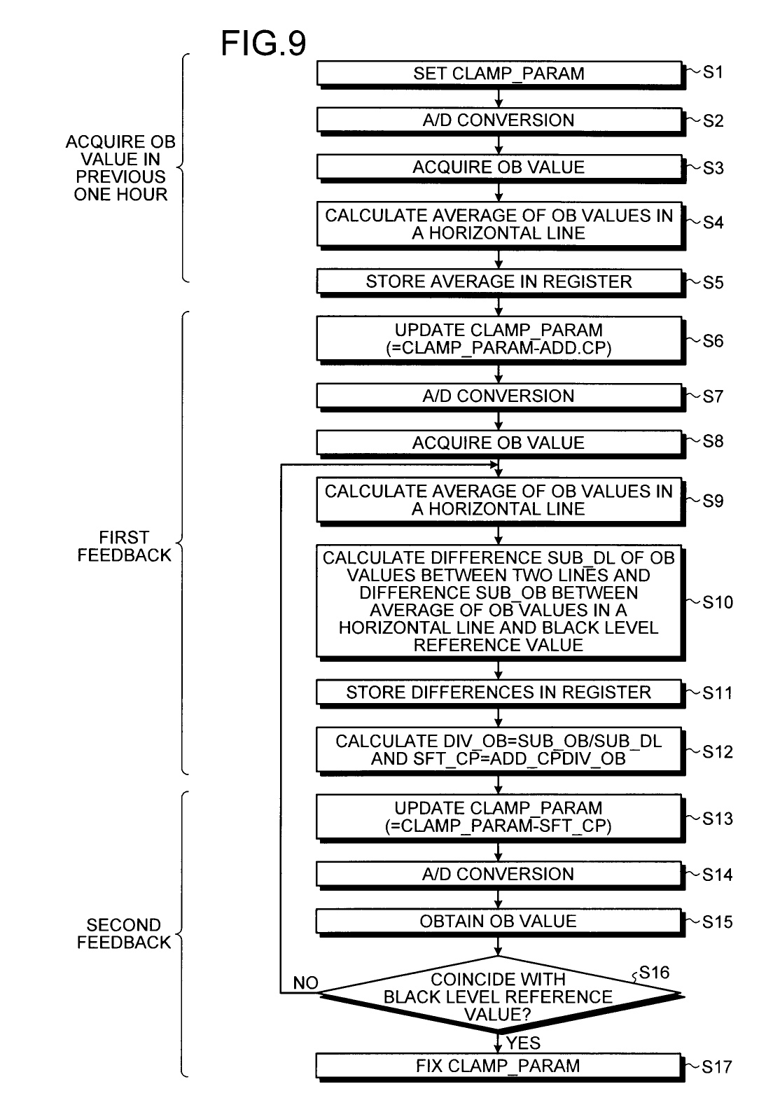

FIG. 9 is a flowchart for explaining operation for generating the clamp parameter CLAMP_PARAM by the clamp-parameter generating circuit 15 shown in FIG. 8. When an execution command for black level correction is input from a not-shown controller, the clamp-parameter generating circuit 15 executes processing indicated by a flow shown in FIG. 9.

In FIG. 9, first, the clamp-parameter updating unit 41 sets the clamp parameter CLAMP_PARAM to the predetermined value (step S1). The VREF generating circuit 17 outputs the set clamp parameter CLAMP_PARAM to the A/D conversion circuit 11. The VREF generating circuit 17 reads out a signal of a line of the pixel unit 10 selected in ADRESn (the first line) and inputs the signal to the A/D conversion circuit 11. The A/D conversion circuit 11 outputs an OB value A/D-converted by using VREF input from the VREF generating circuit 17 (step S2). The OB-value acquiring unit 44 acquires the OB value (step S3). The OB acquiring unit 44 calculates an average of acquired OB values in a horizontal line (step S4) and stores the average in the register 45 (step S5).

Subsequently, the clamp-parameter updating unit 41 updates the clamp parameter CLAMP_PARAM to a value increased or reduced by ADD_CP (step S6). The VREF generating circuit 17 outputs VREF corresponding to the updated clamp parameter CLAMP_PARAM to the A/D conversion circuit 11. The VREF generating circuit 17 reads out a signal of a line selected in ADRESn+1 (the second line) and inputs the signal to the A/D conversion circuit 11. The A/D conversion circuit 11 outputs an OB value A/D-converted by using VREF input from the VREF generating circuit 17 (step S7). The OB-value acquiring unit 44 acquires the OB value (step S8).

The OB acquiring unit 44 calculates an average of acquired OB values in a horizontal line (step S9). The OB-value-change-ratio calculating unit 42 performs subtraction of the average of the OH values in the previous horizontal line stored in the register 45 and the present average of the OB values in a horizontal line and calculates a difference SUB_DL of the averages of the OB values between the two lines. The clamp-increase/decrease determining unit 43 calculates a difference SUB_OB between the present average of the OB values in a horizontal line and the black level reference value (step S10). The clamp-increase/decrease determining unit 43 overwrites the register 45 with the present average of the OB values in a horizontal line (step S11).

The clamp-increase/decrease determining unit 43 divides SUB_OB by SUB_DL to calculate DIV_OB=SUB_OB/SUB_DL and calculates how many times SUB_OB is as large as SUB_DL. The clamp-increase/decrease determining unit 43 outputs SFT_CP (=ADD_CP×DIV_OB) obtained by multiplying ADD_CP and DIV_OB together to the clamp-parameter updating unit 41 (step S12).

The clamp-parameter updating unit 41 increases or reduces the clamp parameter CLAMP_PARAM by SFT_CP to update the clamp parameter CLAMP_PARAM and outputs the updated clamp parameter CLAMP_PARAM (=CLAMP_PARAM-SET-CP) to the VREF generating circuit 17 (step S13).

The VREF generating circuit 17 outputs VREF corresponding to the updated clamp parameter CLAMP_PARAM to the A/D converting circuit 11. The VREF generating circuit 17 reads out a signal of a line selected in ADRESn+2 (the third line) and inputs the signal to the A/D conversion circuit 11. The A/D conversion circuit 11 outputs an OB value A/D-converted by using VREF input from the VREF generating circuit 17 (step S14).

The OB-value acquiring unit 44 acquires the OB value (step S15). The clamp-increase/decrease determining unit 43 determines whether a majority of acquired OB values in horizontal line coincide with the black level reference value (step S16). When the majority of the OB values coincide with the black level reference value (“Yes” at step S16), the OB-value acquiring unit 44 notifies the clamp-parameter updating unit 41 to that effect. The clamp-parameter updating unit 41 fixes a clamp parameter and ends the black level adjustment (step S17). For example, in the case of the condition shown in FIG. 7, the OB value coincides with the black level reference value in the second feedback.

When the majority of the OB values do not coincide with the black level reference value (“No” at step S16), the OB acquiring unit 44 returns to step S9, calculates a present average of the acquired OB values in horizontal line (the third line), performs subtraction of the average of the OB values in the previous horizontal line (the second line) stored in the register 45 and the present average of the OB values in horizontal line, and calculates a difference SUB_DL of the averages of the OB values between the two lines. The clamp-increase/decrease determining unit 43 calculates a difference SUB_OB between the present average of the OB values in a horizontal line and the black level reference value (step S10). The clamp-increase/decrease determining unit 43 overwrites the register 45 with the present average of the OB values in a horizontal line (the third line) (step S11). The processing at steps S12 to S16 is performed. The same processing (S9 to S16) is repeatedly executed until a majority of acquired OB values in a horizontal line coincide with the black level reference value.

As explained above, according to this embodiment, the black-level correcting unit generates a clamp parameter based on the OB value and the black level reference value, feeds back clamp voltage corresponding to the clamp parameter to the A/D conversion circuit 11, and updates the clamp parameter using the linear relation between the clamp parameter and the OB value. Therefore, even when there is fluctuation in a circuit characteristic, it is possible to accurately calculate a correction range used for the black level correction and perform the black level adjustment at high speed.

According to this embodiment, the black-level correcting unit acquires the OB value corresponding to the clamp parameter set to the predetermined value, subtracts the reference adjustment amount from the predetermined value of the clamp parameter to update the clamp parameter, and acquires the OB value corresponding to the updated clamp parameter. The black-level correcting unit subtracts the OB value corresponding to the updated clamp parameter from the OB value corresponding to the clamp parameter set to the predetermined value to calculate the first difference. The black-level correcting unit subtracts the black level reference value from the OB value corresponding to the updated clamp parameter to calculate the second difference. The black-level correcting unit divides the second value by the first value, multiplies the value obtained by the division with the reference adjustment value, and subtracts the value obtained by the multiplication from the updated clamp parameter to update the clamp parameter. Therefore, the black-level correcting unit can calculate the clamp parameter equal to the black level reference value by carrying out the feedback of the clamp parameter once. Therefore, irrespectively of the analog gain and the OB value before the black level adjustment, it is possible to cause the OB value to converge to the black level reference value in the second feedback. In the example explained above, the predetermined value of the clamp parameter is set to a high value and a desired clamp parameter is calculated while the predetermined value is reduced. However, it is also possible that the predetermined value of the clamp parameter is set to a low value and a desired parameter is calculated while the predetermined value is increased.

According to this embodiment, the OB value corresponding to the clamp value set to the predetermined value is the average of the OB values in the n lines of the pixel unit 10. The OB value corresponding to the updated clamp parameter is the average of the OB values in the n+1 lines of the pixel unit 10. Therefore, it is possible to perform the black level correction simply by using the OB values in the two lines.

In this embodiment, the OB value corresponding to the clamp parameter set to the predetermined value is the average of the OB values in the n lines of the pixel unit 10. However, the OB value is not limited to this. An OB value acquired in the last black level correction can be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the sprit of the inventions. The accompanying claims and their equivalents are intended to cover such forms or modifications as would fall within the scope and spirit of the inventions.

What is claimed is:

1. A black level adjusting apparatus that adjusts an imaging signal of an optical black section of a solid-state imaging device such that a pixel signal value (hereinafter, “OB value”) obtained by A/D-converting the imaging signal with an A/D conversion circuit coincides with a black level reference value, the black level adjusting apparatus comprising:
a black-level correcting unit that generates a clamp parameter based on the OB value and the black level reference value and feeds back clamp voltage corresponding to the clamp parameter to the A/D conversion circuit, wherein
the black-level correcting unit updates the clamp parameter using a linear relation between the clamp parameter and the OB value.

2. The black level adjusting apparatus according to claim 1, wherein
the black-level correcting unit includes:
a clamp-parameter updating unit that updates the clamp parameter;
a VREF generating circuit that feeds back clamp voltage corresponding to the clamp parameter updated by the clamp-parameter updating unit to the A/D conversion circuit;
an OB-value-change-ratio calculating unit that subtracts an OB value corresponding to the clamp parameter updated by the clamp-parameter updating unit by subjecting the predetermined value of the clamp parameter and a reference adjustment amount to an arithmetic operation from an OB value corresponding to the clamp parameter set to the predetermined value by the clamp-parameter updating unit to calculate a first difference; and
a clamp-increase/decrease determining unit that subtracts the black level reference value from the OB value corresponding to the updated clamp parameter to calculate a second difference, divides the second difference by the first difference, and multiplies a value obtained by the division with the reference adjustment value to calculate an adjustment value, wherein
the clamp-parameter updating unit subjects the updated clamp parameter and the adjusted value to an arithmetic operation to update the clamp parameter.

3. The black level adjusting apparatus according to claim 2, wherein
the OB value corresponding to the clamp parameter set to the predetermined value is an average of OB values of n lines of the solid-state imaging device, and
the OB value corresponding to the updated clamp parameter is an average of OB values of n+1 lines of the solid-state imaging device.

4. A black level adjusting method for adjusting an imaging signal of an optical black section of a solid-state imaging device such that a pixel signal value (hereinafter, “OB value”) obtained by A/D-converting the imaging signal with an A/D conversion circuit coincides with a black level reference value, the black level adjusting method comprising:
generating a clamp parameter based on the OB value and the black level reference value and feeding back clamp voltage corresponding to the clamp parameter to the A/D conversion circuit, wherein
the generating a clamp parameter and feeding back clamp voltage includes updating the clamp parameter using a linear relation between the clamp parameter and the OB value.

5. The black level adjusting method according to claim 4, wherein
the generating a clamp parameter and feeding back clamp voltage includes:
acquiring an OB value corresponding to the clamp parameter set to the predetermined value;
subjecting the predetermined value of the clamp parameter and the reference adjustment value to an arithmetic operation to update the clamp parameter and acquiring an OB value corresponding to the updated clamp parameter;
subtracting the OB value corresponding to the updated clamp parameter from the OB value corresponding to the clamp parameter set to the predetermined value to calculate a first difference;
subtracting the black level reference value from the OB value corresponding to the updated clamp parameter to calculate a second difference; and
dividing the second difference by the first difference, multiplying a value obtained by the division with the reference adjustment value to calculate an adjustment value, and subjecting the adjustment value and the updated clamp parameter to an arithmetic operation to update the clamp parameter.

6. The black level adjusting method according to claim 5, wherein
the OB value corresponding to the clamp parameter set to the predetermined value is an average of OB values of n lines of the solid-state imaging device, and
the OB value corresponding to the updated clamp parameter is an average of OB values of n+1 lines of the solid-state imaging device.

7. A solid-state imaging device comprising:
a pixel unit in which a plurality of pixels are two-dimensionally arranged;
an A/D conversion circuit that A/D-converts an imaging signal corresponding to charges generated in the pixel unit and generates a pixel signal value;
a timing-generating circuit that controls timing for reading out the imaging signal from the pixel unit;
a black-level correcting unit that adjusts an imaging signal of an optical black section of the pixel unit such that a pixel signal value (hereinafter, “OB value”) obtained by A/D-converting the imaging signal with the A/D conversion circuit coincides with a black level reference value; and
a command control circuit that outputs commands to the timing generating circuit and the black-level correcting unit, wherein
the black level correcting unit generates a clamp parameter based on the OB value and the black level reference value, feeds back clamp voltage corresponding to the clamp parameter to the A/D conversion circuit, and updates the clamp parameter using a linear relation between the clamp parameter and the OB value.

8. The solid-state imaging device according to claim 7, wherein the black-level correcting unit includes:
a clamp-parameter updating unit that updates the clamp parameter;
a VREF generating circuit that feeds back clamp voltage corresponding to the clamp parameter updated by the clamp-parameter updating unit to the A/D conversion circuit;
an OB-value-change-ratio calculating unit that subtracts an OB value corresponding to the clamp parameter updated by the clamp-parameter updating unit by subjecting the predetermined value of the clamp parameter and a reference adjustment amount to an arithmetic operation from an OB value corresponding to the clamp parameter set to the predetermined value by the clamp-parameter updating unit to calculate a first difference; and
a clamp-increase/decrease determining unit that subtracts the black level reference value from the OB value corresponding to the updated clamp parameter to calculate a second difference, divides the second difference by the first difference, and multiplies a value obtained by the division with the reference adjustment value to calculate an adjustment value, wherein
the clamp-parameter updating unit subjects the updated clamp parameter and the adjusted value to an arithmetic operation to update the clamp parameter.

9. The solid-state imaging device according to claim 8, wherein
the OB value corresponding to the clamp parameter set to the predetermined value is an average of OB values of n lines of the solid-state imaging device, and
the OB value corresponding to the updated clamp parameter is an average of OB values of n+1 lines of the solid-state imaging device.

10. The solid-state imaging device according to claim 7, further comprising a lens that focuses light on the pixel unit.
